(19) United States
(12) Patent Application Publication
(10) Pub. No.: US 2010/0300370 A1
(43) Pub. Date: Dec. 2, 2010

(54) Ventilated box enclosure

(75) Inventor: Adam Nathan Hundt, Seattle, WA (US)

Correspondence Address: ADAM NATHAN HUNDT, 2314 SOUTH GRAHAM STREET, SEATTLE, WA, 98108, US

(73) Assignee: TARANTULACAGES.COM, Seattle, WA (US)

(21) Appl. No.: 12/455,573

(22) Filed: Jun. 2, 2009

(51) Int. Cl. A01K 1/03; B32B 37/12; E04B 1/70

(52) U.S. Cl. 119/452; 156/60; 156/71; 52/745.15

(57) ABSTRACT

A ventilated box enclosure for addressing the deficiencies of current terrarium designs is disclosed. At least six extruded acrylic sheets are used to form the ventilated box enclosure. The ventilated box enclosure comprises a top, a bottom, and vertical sides. Either the top or one of the vertical sides is hinged to an adjacent vertical side to form a hinged door. The door is hinged by at least two acrylic hinges. The hinged door is released open or secured shut by at least a pair of lockable hasps. Three or more screen vents ventilate the box enclosure, wherein at least one vent is located on the top and at least one vent is located at each of two diametrically opposite vertical sides. The edges of each acrylic sheet of the box enclosure are flame polished to a smooth finish.

### BACKGROUND

Many people have small creatures, including, but not limiting to spiders, snakes, frogs, other crawling, creeping, and climbing creatures, or amphibians as pets (collectively hereinafter as “pets”). These people rely on a terrarium to house their pets amongst foliage, terrain, and environment suitable for the pets. Sometimes, the terrarium is too large to visually enjoy a pet, because the pet can easily hide or camouflage itself in the foliage, terrain, or suitable environment. At other times, the terrarium is too bulky or unsafe to move without causing harm or stress to the pet, or without first moving the pet to another temporary location before moving the terrarium. At still other times, the terrarium is too small for the pet, which could inhibit the pet's growth. At yet still other times, not enough or too much ventilation (which could also be directly related to the size of the terrarium) can cause excess humidity or arid conditions, respectively, which could adversely affect the pet causing death in some instances. Current terrariums have some or all of the above problems. These problems can be better understood by a review of current terrarium designs.

FIG. 1 illustrates a current terrarium design 100 where the top 110 and open able door 120 are screened to allow for airflow. The base 130 is water tight with sides 140 and 150, and back 160, which are all made of glass whose edges are sealed watertight. The watertight base allows for a pool of water up to the bottom of the open able door 120. This terrarium design comes in just one style, so is sometimes too large to visually enjoy some pets or too small for others. Made mainly of glass with two large screened areas, this terrarium design also has some of the other problems discussed, namely, too bulky or unsafe to move, and too much ventilation due to the all screen door and top which could cause arid like conditions inside the terrarium, especially if there is little or no pool of water at the base.

FIG. 2 illustrates another current terrarium design 200 with fully glass constructed sides 210 and 220, back 230, and glass open able front door 240. The top is a screen 250 made of stainless steel. The base 260 is watertight, which could allow for a pool of water up to the bottom of the open able glass door. The top accommodates a dome clamp lamp fixture 270 to help in reducing humidity and allowing for UVA and UVB light. There is a wood trim 280 around the base for added decoration and stability. This terrarium design comes in just one size. Like the terrarium discussed at FIG. 1, this terrarium design also suffers from some of the problems discussed, namely, too large or too small for some pets, too bulky or unsafe to move due to the all glass, stainless steel, and wood construction, and too much ventilation due to the lamp fixture which could cause arid like conditions inside the terrarium, especially if there is little or no pool of water at the base.

Based on the above-described deficiencies associated with current terrarium designs, there exists a need for a terrarium design that can be configured for all sizes of pets while maintaining a clear visual enjoyment of the pets, is not too bulky or unsafe to move or without first moving the pets to a temporary location, and has the correct amount of ventilation so that there is never too much humidity or arid like conditions created within the terrarium, which can be fatal for the pets.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A ventilated box enclosure for addressing the deficiencies of current terrarium designs is disclosed. According to one embodiment, at least six extruded acrylic sheets are used to form the box enclosure comprising a top, a bottom, and vertical sides. According to another embodiment, either the top or one of the vertical sides is hinged to an adjacent vertical side to form a hinged door. According to another embodiment, the hinged door is released open or secured shut by at least a pair of lockable hasps. According to another embodiment, three or more screen vents, preferably circular screen vents ventilate the box enclosure, wherein at least one vent is located on the top and at least one vent is located at each of two diametrically opposite vertical sides. According to another embodiment, the edges of each acrylic sheet are flame polished to a smooth finish.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram of an exemplary prior art terrarium design;

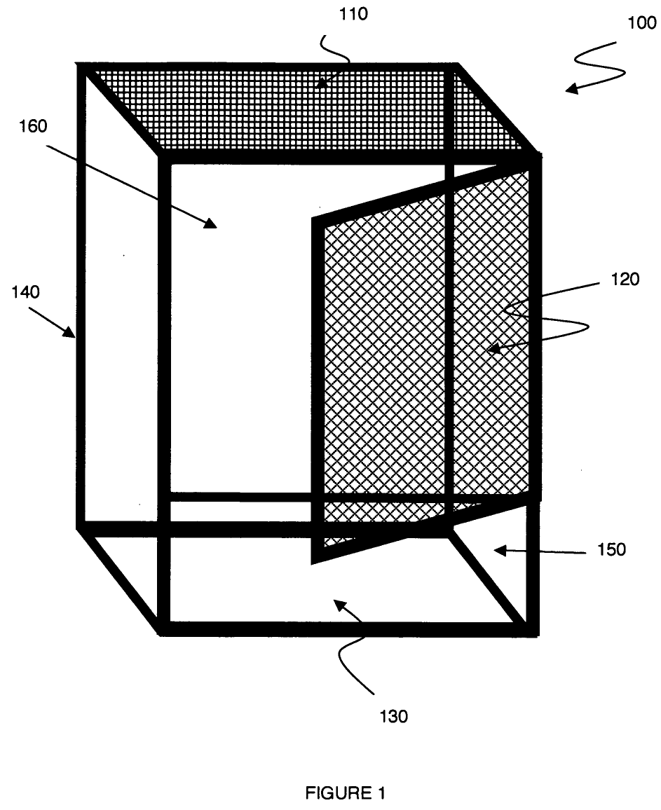

FIG. 2 is a pictorial diagram of another exemplary prior art terrarium design;

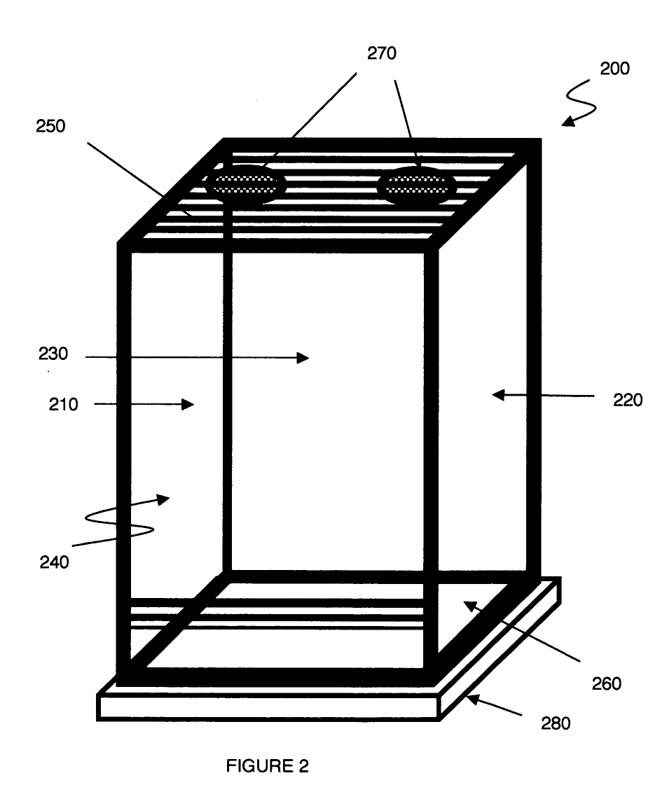

FIG. 3 is a pictorial diagram of an exemplary ventilated box enclosure, according to one embodiment of the disclosed subject matter;

FIG. 4 is another pictorial diagram of an exemplary ventilated box enclosure, according to another embodiment of the disclosed subject matter;

FIG. 5 is yet another pictorial diagram of an exemplary ventilated box enclosure, according to yet another embodiment of the disclosed subject matter.

### DETAILED DESCRIPTION

In the following description, numerous specific details are set forth to provide a more thorough description of the illustrative embodiments of the invention. It will be apparent, however, to one skilled in the art that the invention may be practiced without these specific details. In other instances, well known features have not been described in detail so as not to obscure the invention.

A ventilated box enclosure for housing pets is disclosed. According to one embodiment, the length of the box enclosure ranges from 6″ to 20″, while the width of the box enclosure ranges from 5″ to 12″ and the height of the box enclosure ranges from 7″ to 20″. It should be noted that the length, width, and height ranges of the box enclosure are exemplary and not limiting in anyway, and that the disclosed subject matter equally applies to a box enclosure with length, width, and height dimensions not specifically mentioned in the above ranges. Unlike current terrarium designs that come in just one size, the range of length, width, and height dimensions of the box enclosure can accommodate a wider range of pets. Accordingly, a pet owner can chose a box enclosure size to fit a pet so that the box enclosure is not too small or too large for the pet, which is a deficiency with current terrarium designs.

According to another embodiment, the box enclosure is made of clear acrylic sheets. According to another embodiment, the thickness of the clear acrylic sheet is 3/16″. According to another embodiment, the edges of the 3/16″ thick clear acrylic sheet are flame polished to a smooth finish to prevent skin cuts or abrasions to pets and its handler, and to add an aesthetic appeal. According to another embodiment, the clear acrylic sheets are bonded together with a solvent type-bonding agent, for example acrylic cement, to form the box enclosure. According to another embodiment, either a top or a vertical side of the box enclosure is hinged to an adjacent vertical side by at least a pair of hinges to form a hinged door. According to another embodiment, the hinges are made of clear acrylic. The hinges are bonded to the top or vertical side using the solvent type-bonding agent, for example acrylic cement. According to another embodiment, the top or the vertical side that is hinged to form the hinged door is released open or secured shut by a pair of lockable hasps. According to another embodiment, the lockable hasps are made of clear acrylic. The lockable hasps are bonded to the box enclosure using the solvent type-bonding agent, for example acrylic cement.

According to another embodiment, the box enclosure is ventilated using at least three screen vents, preferably circular screen vents. According to another embodiment, the holes of the screen are large enough to allow airflow yet small enough to ensure that even the smallest size pet is not able to pass through it. According to another embodiment, an aluminum ring casing houses the circular screen vents. According to another embodiment, a circular hole is cut at specific locations on the box enclosure where an aluminum ring casing along with the screen vent is to be affixed. According to another embodiment, the aluminum ring casing along with the screen vent is bonded to the top and/or two diametrically opposite vertical sides of the box enclosure, wherein there is at least one aluminum ring casing with the screen vent for the top and at least one aluminum ring casing with the screen vent for each of two diametrically opposite vertical sides of the box enclosure. According to another embodiment, the screen is compressed within the aluminum ring casing, and the aluminum ring casing is bonded to the box enclosure using the solvent type-bonding agent, for example acrylic cement. According to another embodiment, the aluminum ring casing is 2″ in diameter.

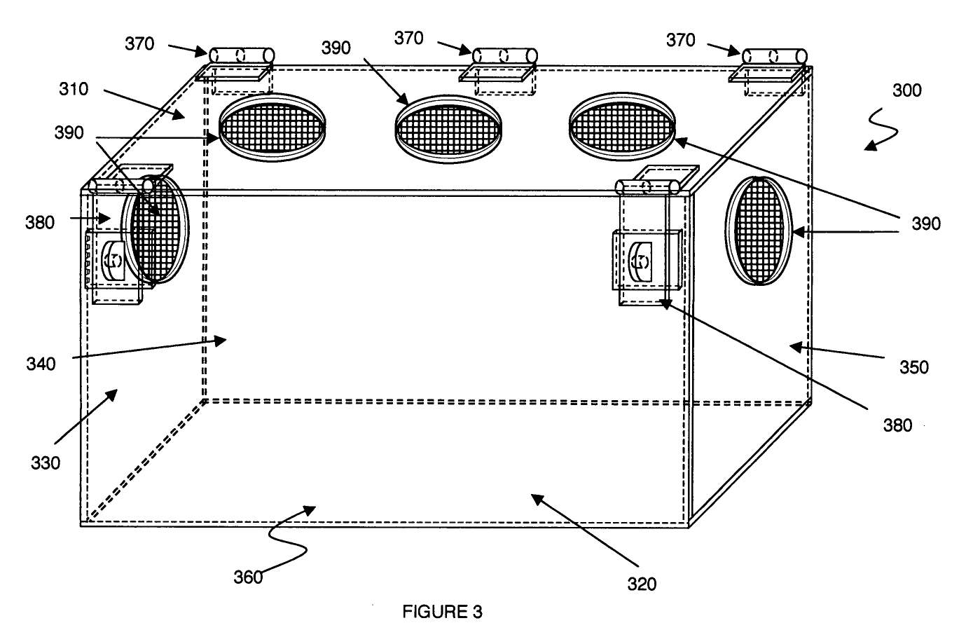

According to another embodiment, six sheets of the clear acrylic are used to form a box enclosure with a top, bottom, and four vertical sides. FIG. 3 illustrates a pictorial diagram of this embodiment. Box enclosure 300 comprises of top 310, bottom 320, and four vertical sides 330-360. The top 310 is hinged to vertical side 340 with three clear acrylic hinges 370. The top 310 forms the hinged door that is released open or secured shut by a pair of lockable hasps 380 made of clear acrylic. The box enclosure 300 also comprises five screen vents 390, wherein the top 310 comprises three screen vents and opposite sides 330 and 350 each comprise one screen vent.

According to another embodiment, seven sheets of the clear acrylic are used to form a box enclosure with a top, bottom, and four vertical sides, where one of the vertical sides is made of two clear acrylic sheets such that a top clear acrylic sheet forms a hinged door and a bottom clear acrylic sheet is fixed to the bottom and the two adjacent vertical sides to form a fixed section. According to another embodiment, the two clear acrylic sheets that form the hinged door and fixed section are of different vertical dimensions. According to another embodiment, the two sheets that form the hinged door and fixed section are of same vertical dimensions.

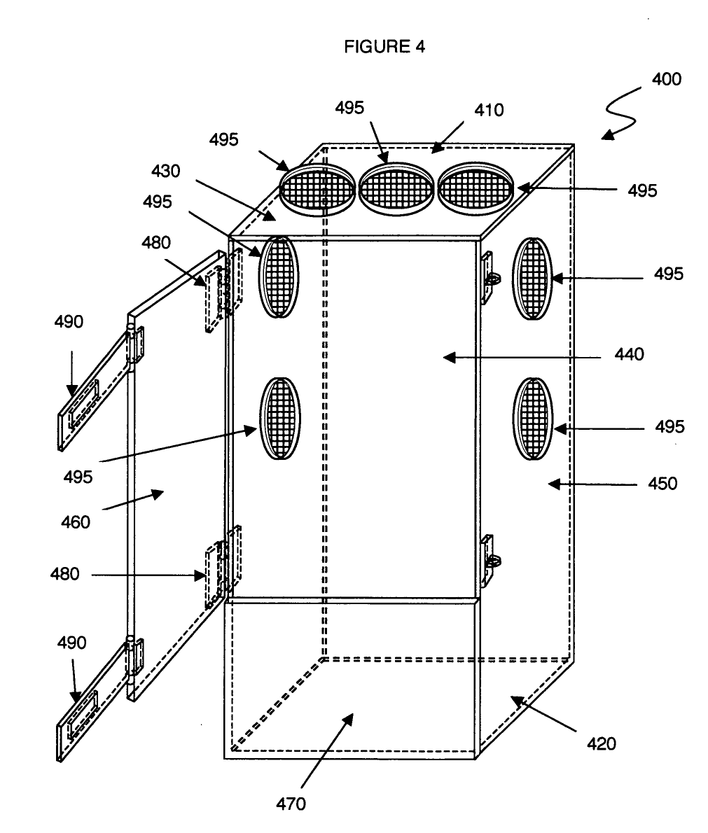

FIG. 4 illustrates a pictorial diagram of a box enclosure 400 as described above. Box enclosure 400 comprises a top 410, a bottom 420, and four vertical sides 430-470, wherein side 460 forms a hinged door and side 470 is fixed to the bottom 420 and adjacent vertical sides 430 and 450 to form the fixed section. Hinged door 460 pivots about a pair of hinges 480 made of clear acrylic and is released open or secured shut by a pair of lockable hasps 490 also made of clear acrylic. The box enclosure 400 also comprises seven vents 495, wherein the top 410 comprises three screen vents and opposite sides 430 and 450 each comprise a pair of screen vents.

According to another embodiment, 7 sheets of the clear acrylic are used to form the box enclosure with a top, bottom, and four vertical sides. The top forms a hinged door. The seventh sheet forms a vertical side inside the box enclosure. In this embodiment, the vertical side inside the box enclosure divides the box enclosure into two compartments. The vertical side inside the box enclosure extends from the bottom of the box enclosure to the hinged top such that the box enclosure can house pets in each compartment and the pets cannot cross over from one compartment to the other.

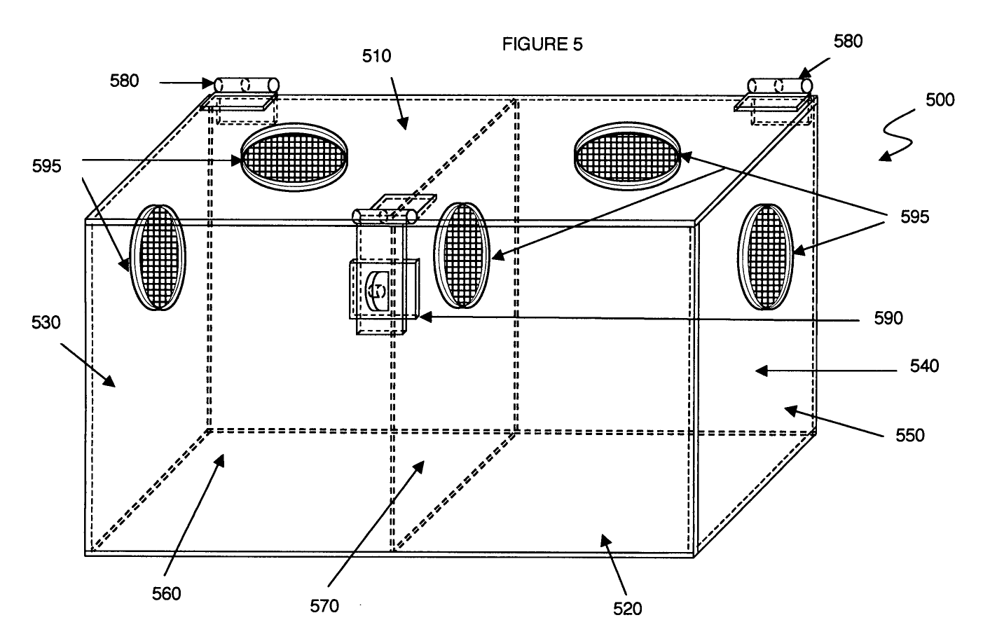

FIG. 5 illustrates a pictorial diagram of a box enclosure 500 as described above. Box enclosure 500 comprises a top 510, bottom 520, four vertical sides 530-560, and vertical side 570 that divides the box enclosure into two compartments. Top 510 forms a hinged door that pivots about a pair of hinges 580 made of clear acrylic and is released open or secured shut by a lockable hasp 590 also made of clear acrylic. The vertical side 570 extends from the top 510 to the bottom 520 such that when the top 510 is secured shut, a pet cannot cross over from one compartment to another. The box enclosure 500 also comprises five vents 595. The top 510 comprises two screen vents, one each for the two compartments. Vertical sides 530, 550, and 570 each comprise a screen vent.

While illustrative embodiments have been illustrated and described, it will be appreciated that various changes can be made therein without departing from the spirit and scope of the disclosed subject matter. Thus, while preferred embodiments for a ventilated box enclosure are described herein, it is to be understood that the embodiments of the disclosed subject matter are not limited to the described embodiments but rather by the following claims and their full scope of equivalents.

The embodiments of the invention in which an exclusive property or privilege is claimed are defined as follows:

1. A ventilated box enclosure for housing pets, comprising:
a rectangular top section with at least one cutout portion to accommodate a screen vent;
a rectangular bottom section with a dimension equal to the rectangular top section; and
at least four vertical sections wherein the at least four vertical sections bridge the rectangular top and bottom sections to form the box enclosure and wherein at least a pair of diametrically opposite vertical sections each comprise at least a cutout portion to accommodate at least another screen vent.

2. The ventilated box enclosure of claim 1 is made of 3/16″ thick extruded acrylic sheets bonded together with a solvent type-bonding agent, and wherein edges of the 3/16″ thick acrylic sheets are flame polished to a smooth finish.

3. The ventilated box enclosure of claim 2, wherein either the rectangular top section or one of at least four vertical sections is hinged to an adjacent vertical section by at least a pair of hinges, wherein the hinges are made of extruded acrylic and bonded to the box enclosure with a solvent type-bonding agent.

4. The ventilated box enclosure of claim 3, wherein either the hinged top section or one of at least four vertical sections is released open or secured shut by at least a pair of lockable hasps, wherein the lockable hasps are made of extruded acrylic and bonded to the box enclosure with a solvent type-bonding agent.

5. The ventilated box enclosure of claim 1, wherein each screen vent is compressed within an aluminum ring casing, and the aluminum ring casing is bonded over the cutout portions of the box enclosure using a solvent type-bonding agent.

6. The ventilated box enclosure of claim 5, wherein the cutout portions of the box are 2″ in diameter.

7. An apparatus for housing pets, comprising:
a rectangular top section with means to accommodate at least a screen vent;
a rectangular bottom section with a dimension equal to the rectangular top section; and
at least four vertical sections, wherein the at least four vertical sections bridge the rectangular top and bottom sections to form the apparatus, and wherein at least a pair of diametrically opposite vertical sections each comprise a means to accommodate at least another screen vent.

8. The apparatus of claim 7 is made of 3/16″ thick extruded acrylic sheets bonded together with a solvent type-bonding agent, and wherein edges of the 3/16″ thick acrylic sheets are flame polished to a smooth finish.

9. The apparatus of claim 8, wherein either the rectangular top section or one of at least four vertical sections is attached by means to an adjacent vertical section.

10. The apparatus of claim 9, wherein the means is performed by at least a pair of hinges, wherein the hinges are made of extruded acrylic and bonded to the apparatus with a solvent type-bonding agent.

11. The apparatus of claim 9, wherein either the rectangular top section or one of at least four vertical sections is released open or secured shut by means to a vertical section.

12. The apparatus of claim 11, wherein the means is performed by at least a pair of lockable hasps, wherein the lockable hasps are made of extruded acrylic and bonded to the apparatus with a solvent type-bonding agent.

13. The apparatus of claim 7, wherein each screen vent is compressed within an aluminum ring casing and the aluminum ring casing is bonded over the cutout portions of the box enclosure using a solvent type-bonding agent.

14. The apparatus of claim 13, wherein the cutout portions of the box are 2″ in diameter.

15. A method of making a ventilated box enclosure for housing pets, comprising:
cutting out at least one portion in a rectangular top section to accommodate a screen vent;
constructing a rectangular bottom section with a dimension equal to the rectangular top section;
bridging at least four vertical sections to the rectangular top and bottom sections to form the box enclosure; and
cutting out at least one portion in at least a pair of diametrically opposite vertical sections to accommodate another screen vent.

16. The method of claim 15, wherein the ventilated box enclosure is made of 3/16″ thick extruded acrylic sheets bonded together with a solvent type-bonding agent, and wherein edges of the 3/16″ thick acrylic sheets are flame polished to a smooth finish.

17. The method of claim 16 further comprising:
hinging either the rectangular top section or one of at least four vertical sections to an adjacent vertical section by at least a pair of hinges, wherein the hinges are made of extruded acrylic and bonded to the box enclosure with a solvent type-bonding agent.

18. The method of claim 17 further comprising:
releasing open or securing shut either the hinged top section or one of at least four vertical sections by at least a pair of lockable hasps, wherein the lockable hasps are made of extruded acrylic and bonded to the box enclosure with a solvent type-bonding agent.

19. The method of claim 15 further comprising:
compressing each screen vent to an inside surface of an aluminum ring casing and bonding the aluminum ring casing using a solvent type-bonding agent over the cutout portions of the box enclosure.

20. The method of claim 5, wherein the cutout portions of the box are 2″ in diameter.
